(19) United States
(12) Patent Application Publication
(10) Pub. No.: US 2025/0361365 A1
(43) Pub. Date: Nov. 27, 2025

(54) Seaweed-Derived Insulation and Method of Preparation

(71) Applicant: Aspen Products Group, Inc., Marlborough, MA (US)

(72) Inventors: Mark Fokema, Northborough, MA (US); Decio Coutinho, Marlborough, MA (US)

(21) Appl. No.: 19/079,860

(22) Filed: Mar. 14, 2025

Related U.S. Application Data
(60) Provisional application No. 63/649,989, filed on May 21, 2024.

(51) Int. Cl. C08J 3/00; B01J 13/00; C08J 3/24; C08J 9/00; C08J 9/28

(52) U.S. Cl. CPC C08J 3/005; B01J 13/0065; B01J 13/0069; C08J 3/24; C08J 9/0019; C08J 9/0023; C08J 9/0028; C08J 9/28

(57) ABSTRACT

Insulation can be manufactured by subjecting a liquid suspension of seaweed to shear to reduce particle size, to release seaweed fibers from the seaweed matrix, and to form a seaweed dispersion. Gelation of the seaweed dispersion is then induced to form a gel comprising a liquid containing a three-dimensional network of the seaweed fibers. The gel is then dried. Thermal insulation that can be produced by these methods includes a network of fibers that define pores with dimensions smaller than 1 micron. The network of fibers can comprise 70-98 weight percent seaweed and 2-30 weight percent crosslinker.

### RELATED APPLICATION

This application claims the benefit of U.S. Provisional Application No. 63/649,989, filed 21 May 2024, the entire content of which is incorporated herein by reference.

### GOVERNMENT SUPPORT

This invention was made with government support under award number DE-AR0001642, awarded by the Advanced Research Projects Agency-Energy (ARPA-E). The US government has certain rights in the invention.

### BACKGROUND

The present disclosure relates to methods for preparing insulating materials from seaweed-derived feedstocks. The insulating materials can be used in both thermal and acoustic applications.

The transfer of thermal energy through materials occurs via a combination of conductive, convective, and radiative mechanisms. Most thermal insulations exhibit low-density porous microstructures that minimize both conductive heat transport (by reducing the concentration of solids present in the insulation) and convective heat transport (by restricting the movement of air within the pores of the insulation). High-performance thermal insulations are particularly realized as the pore size of the insulation is reduced below the mean free path length of air, which is below 0.1 microns (μm) at ambient conditions.

Insulations derived from renewable feedstocks, such as wool, wood fibers, cotton, and cellulose, offer a sustainable means of reducing heat transfer across building, packaging, appliance, and industrial equipment envelopes; but they tend to exhibit poor insulation performance (i.e., R-values of less than 4 per inch) due to their suboptimal pore structures. Synthetic insulations, such as polymer foams and aerogels, offer much higher insulation values (i.e., R-values of 5 to 10 per inch) because their microstructures and compositions have been specifically engineered to reduce conductive, convective, and radiative heat transfer. Synthetic insulations, however, are generally derived from non-renewable resources and produced using large amounts of energy, and are thus expensive and contain high embodied emissions.

Seaweed, or macroalgae, are plant-like organisms that grow in marine environments and may be either free-floating or anchored to substrata in coastal areas. They are generally classified into three different phyla on the basis of the color of their thallus: brown, red, and green. Regardless of color, all species of seaweed fix atmospheric CO₂ into sugars, biopolymers, and other organic molecules via photosynthesis, and are thus considered to be a renewable and sustainable resource.

Although terrestrial plants are often used as insulation (e.g., wood fiber, cellulose, straw, hemp, etc.), seaweed is not currently widely used as insulation. Seaweed was historically used as a roof thatch, which provides some insulating value, and was also sometimes loosely packed into wall cavities in coastal areas; but low insulation performance and the implementation of building codes have reduced this practice. In recent years, efforts to convert fibrous seaweeds into insulation batts have been undertaken, but the R-values of these products are comparable to that of other natural fiber insulations (i.e., less than 4 R per inch).

The lower fiber content and higher sugar content of seaweeds relative to terrestrial plant-derived feedstocks make the production of high-performance insulation from seaweed challenging. The higher inorganic/salt content of seaweed can also lead to processing challenges, but at the same time, has been shown to impart some flame-retardant characteristics to seaweed-derived products.

### SUMMARY

A method for manufacturing an insulation and a thermal insulation that can be produced by the method are described herein, where various embodiments of the insulation and methods may include some or all of the elements, features, and steps described below.

In a method for manufacturing an insulation, a liquid suspension of seaweed is subjected to shear to reduce particle size, to release seaweed fibers from the seaweed matrix, and to form a seaweed dispersion. Gelation of the seaweed dispersion is then induced to form a gel comprising a liquid containing a three-dimensional network of the seaweed fibers. The gel is then dried.

The liquid suspension of seaweed can be formed by mixing seaweed with water at a seaweed concentration of less than 8 weight percent. The shear can be created within a blender, homogenizer, microfluidizer, refiner, supermasscolloider, or ultrasonicator; and the shear can be generated by supplying less than 10 kWh of energy per kg seaweed to the blender, homogenizer, microfluidizer, refiner, supermasscolloider, or ultrasonicator to generate the shear.

The seaweed fibers can have an average diameter of less than 0.1 microns. Gelation can be induced by mixing a crosslinker into the seaweed dispersion and heating the mixture. The crosslinker can comprise a polyamine and epichlorohydrin.

The method can further include bleaching or oxidizing the seaweed, and the bleached or oxidized seaweed fibers can include less than 0.3 mmol carboxyl per gram of seaweed.

In some exemplifications, the liquid can be replaced with a solvent prior to drying.

The gel can be dried by replacing the liquid contained in the pores of the gel with air via supercritical drying, freeze drying, or ambient-pressure drying. In some exemplifications, the gel can be dried by replacing the liquid contained in the pores of the gel with camphor dissolved in a solvent and then heating the gel to evaporate the solvent and to sublime the camphor.

The insulation can have a bulk density between 0.02 and 0.2 g/cm³ and/or can have an average pore dimension of less than 1 micron. Further, the insulation can exhibit a thermal conductivity of less than 30 mW/mK.

A thermal insulation that can be produced by these methods includes a network of fibers that define pores with dimensions smaller than 1 micron. The network of fibers can comprise 70-98 weight percent seaweed and 2-30 weight percent crosslinker. In other exemplifications, the network of fibers can comprise 90-99 or 95-99 weight percent seaweed, with the balance being or essentially being the crosslinker.

Described herein are methods that yield high-performance insulation (i.e., with an R-value per inch greater than 5) that is primarily comprised of seaweed.

In an illustrative embodiment, a method for preparing seaweed-derived insulation involves subjecting a suspension of seaweed to a high-shear environment, inducing gelation of the seaweed suspension into a gel comprising a three-dimensional network of seaweed fibers, and then drying the gel.

The dried gel contains submicron-sized pores and can be employed as thermal or acoustic insulation.

In particular embodiments, the dried seaweed gel is used in thermal-insulation applications, as the porous structure of the material inhibits the transfer of heat via conductive, convective, and radiative mechanisms. The insulation can have a thermal conductivity of less than 35 mW/mK, less than 30 mW/mK, less than 25 mW/mK, less than 20 mW/mK, or even less than 15 mW/mK at 25° C. The insulation can be employed to reduce heat loss from buildings, appliances, automobiles, aircraft, marine vessels, shipping containers, electronic devices, and industrial equipment.

By enabling the production of high-performance (i.e., low thermal conductivity and/or high acoustic attenuation) insulation from seaweed, the methods disclosed herein offer the potential for displacement of petrochemical-based insulation products with sustainable and inexpensive alternatives. Other advantages to the use of marine-based plants over terrestrial-based plants include the ability to produce seaweed with no land use, freshwater irrigation, or fertilizer concerns.

The methods described herein can overcome numerous shortcomings associated with the production of current insulation products, including 1) low insulation value, 2) use of petroleum-derived and other non-renewable feedstocks, 3) high energy consumption, 4) poor flammability resistance, and 5) high cost. These and other advantages and attainments of embodiments of the present invention will become apparent to those skilled in the art upon reading the following detailed description and illustrative embodiments of the invention.

### BRIEF DESCRIPTION OF THE DRAWINGS

In the course of the following detailed description, reference will be made to the attached drawings in which:

FIG. 1 is a schematic representation of seaweed being processed to form insulation.

FIG. 2 is a magnified photographic image of a fibrillated seaweed suspension.

FIG. 3 is a magnified photographic image of a fibrillated bleached softwood kraft pulp suspension.

FIG. 4 is a magnified photographic image of a fibrillated flax suspension.

FIG. 5 is a magnified photographic image of a seaweed insulation.

FIG. 6 is a magnified photographic image of a seaweed insulation.

FIG. 7 is a magnified photographic image of an oxidized seaweed insulation.

The drawings are not necessarily to scale; instead, an emphasis is placed upon illustrating particular principles in the exemplifications discussed below.

### DETAILED DESCRIPTION

The foregoing and other features and advantages of various aspects of the invention(s) will be apparent from the following, more particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used, or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures, and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations), and the spatially relative descriptors used herein are to be interpreted accordingly. The term, “about,” can mean within ±5% or ±10% of the value recited. In addition, where a range of values is provided, each subrange and each individual value between the upper and lower ends of the range is contemplated and, therefore, disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein to describe particular embodiments is not intended to limit the represented concepts to the particulars of the exemplary embodiments. As used herein, singular forms, such as “a” and “an,” are intended to include the plural forms as well unless the context indicates otherwise. Additionally, the terms, “includes,” “including,” “comprises,” and “comprising,” specify the presence of the stated elements or steps but do not preclude the presence or addition of one or more other elements or steps.

The term, “seaweed,” is used herein to designate biomass derived from multicellular marine algae that are visible to the naked eye.

The term “fiber,” is used herein to designate a solid material that is much longer in one direction than other directions. Fibers are typically circular or elliptical in cross-section and exhibit an aspect ratio (length divided by diameter) greater than 10. An organic fiber typically comprises multiple polymeric molecular chains that are aggregated into a supramolecular structure. Individual molecular chains, such as seaweed polysaccharides that dissolve in water, are not considered to be fibers in and of themselves.

The term “suspension,” is used herein to designate a system in which solids are distributed within a continuous liquid phase. Suspended solids typically settle out of a suspension when the suspension is not agitated.

The term “dispersion,” is used to herein designate a system in which insoluble solid particles or fibers are dispersed or distributed within a continuous liquid phase.

The term, “gel,” is used herein to designate a three-dimensional network of solid material that contains fluid-filled pores and is characterized by a low solids fraction—typically less than 10 volume percent.

The term, “solvent,” is used herein to designate an organic liquid that dissolves a solute to form a solution.

The term, “R-value,” is used herein to designate a thermal resistance defined as the temperature difference across a barrier divided by the heat flux through the barrier, in units of ° Fft²h/BTU. R-value per inch is defined as the R-value divided by the thickness of the barrier. R-value per inch is approximately equal to 0.144 divided by the thermal conductivity (expressed in units of W/mK).

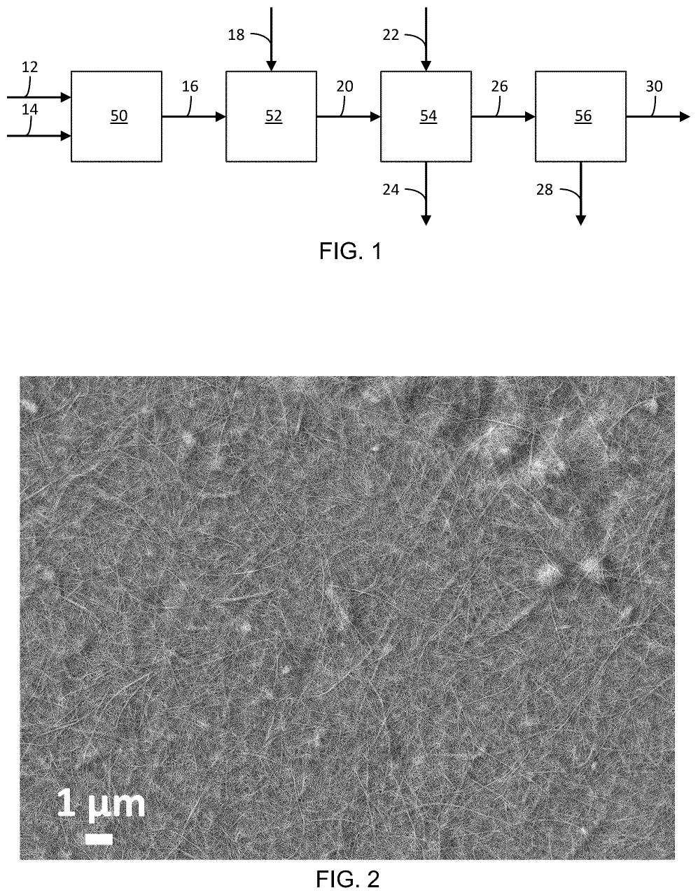

Now, referring to FIGS. 1-7, features and details of methods for producing seaweed-derived insulation are described. Particular embodiments are detailed below for the purpose of illustration and not as limitations of the invention.

### Insulation Preparation

FIG. 1 is a representation of an exemplary process that can be employed to produce the insulation. In the first stage of the process, seaweed 12 and a liquid 14 are mixed together to form a suspension in a high-shear mixer 50. The high-shear environment reduces the particle size of the seaweed and fibrillates the fibers present in the seaweed into smaller diameter fibers to produce a seaweed dispersion 16.

In various exemplifications, the liquid 14 can be water, methanol, ethanol, 1-propanol, 2-propanol, 1-butanol, 2-butanol, isobutanol, tert-butanol, acetone, butanone, or mixtures thereof. The liquid suspension of seaweed 12 typically includes less than about 15-weight-percent solids—e.g., less than about 8-weight-percent solids, less than about 4-weight-percent solids, less than about 2-weight-percent solids, or, in more particular embodiments, at most 1-weight-percent solids. The high-shear environment can be produced within a blender, homogenizer, microfluidizer, refiner, supermasscolloider (an ultrafine grinder), or ultrasonicator (an ultrasonic homogenizer) with an energy input of typically less than about 10 kWh/kg seaweed—e.g., less than about 6 kWh/kg seaweed, less than about 4 kWh/kg seaweed, less than about 2 kWh/kg seaweed, or, in more particular embodiments, at most 1 kWh/kg seaweed. The fibers included in the seaweed dispersion 16 typically exhibit an average fiber diameter of greater than 0.002 microns and less than about 1 micron—e.g., less than about 0.4 microns, less than about 0.1 microns, less than about 0.05 microns, or, in more particular embodiments, at most 0.02 microns.

Referring again to FIG. 1, in the second stage of the process, the seaweed dispersion 16 is mixed with crosslinker 18 and then heated in a mold 52 to induce a reaction between the crosslinker and the seaweed fibers to form a seaweed gel 20.

In various exemplifications, the crosslinker can be a bi-or multi-functional organic compound capable of reacting with and binding to the seaweed fiber's surface moieties, such as hydroxyl and carboxyl. The crosslinker can be a dialdehyde, such as glutaraldehyde or glyoxal; a diamine, such as 1,2-diaminomethane or phenylenediamine; a polyamine, such as diethylenetriamine or polyethyleneimine; an epoxide, such as epichlorohydrin or diepoxybutane; an epoxy resin; an isocyanate, such as methylene diphenyl diisocyanate or hexamethylene diisocyanate; a polycarboxylic acid, such as citric acid or butanetetracarboxylic acid; or mixtures thereof. The crosslinker may also be a multivalent cationic species, such as Mg²⁺, Ca²⁺, Sc³⁺, Ti⁴⁺, V⁵⁺, Cr³⁺, Mn²⁺, Fe³⁺, Co³⁺, Ni²⁺, Zn²⁺, Sr²⁺, Ba²⁺, or mixtures thereof. The crosslinker content of the seaweed gel is typically less than about 30 weight percent—e.g., less than about 20 weight percent, less than about 10 weight percent, less than about 5 weight percent, less than about 2 weight percent, or, in more particular embodiments, at most 1 weight percent. The crosslinking temperature is typically less than about 125° C.—e.g., less than about 90° C., less than about 70° C., less than about 50° C., less than about 35° C., or, in more particular embodiments, at most about 25° C.

Referring again to FIG. 1, in the third stage of the process, the seaweed gel 20 is exposed to an exchange solvent 22 in an exchange bath 54 to displace the liquid contained in the pores of the seaweed gel 20 and to produce an exchanged solvent 24, which is enriched in the liquid, and a solvent-exchanged gel 26, the pores of which contain a fluid that is solvent-rich and liquid-poor.

The exchange solvent 22 has properties that facilitate the subsequent removal of solvent from the pores of the solvent-exchanged gel 26 without damaging the pores due to excessive capillary forces. These properties typically include low surface tension (e.g., less than 25 mN/m), neutral wetting angle (e.g., between 80 and 100°), low critical temperature (e.g., less than 100° C.), low critical pressure (e.g., less than 5 MPa), or combinations thereof. In various exemplifications, the exchange solvent 22 can be an alcohol, methanol, ethanol, 1-propanol, 2-propanol, 1-butanol, 2-butanol, isobutanol, tert-butanol, acetone, butanone, 2-pentanone, 3-pentanone, 2-methoxyethanol, 2-ethoxyethanol, 2-propoxyethanol, 2-isopropoxyethanol, 1-methoxy-2-propanol, 3-methoxy-1-propanol, 1-ethoxy-2-propanol, 3-ethoxy-1-propanol, 1,1-dimethoxyethane, 1,2-dimethoxyethane, dimethylformamide, pyridine, acetonitrile, tetrahydrofuran, diethylether, methyl tert-butylether, liquid carbon dioxide, or mixtures thereof. The fluid in the pores of the solvent-exchanged gel 26 typically includes greater than about 70-weight-percent solvent—e.g., greater than about 80-weight-percent solvent, greater than about 90-weight-percent solvent, greater than about 95-weight-percent solvent, greater than about 97-weight-percent solvent, or in more-particular embodiments, greater than about 99-weight-percent solvent.

Referring again to FIG. 1, in the fourth stage of the process, the solvent-exchanged gel 26 is dried in a drier 56 to produce a solvent 28 and a dried insulation 30, the pores of which are filled with air.

Removal of the solvent 28 is conducted under conditions that minimize collapse of the porous structure of the solvent-exchanged gel 26. The drying conditions may comprise solvent removal above the critical temperature and critical pressure of the solvent (i.e., supercritical drying), below the freezing point of the solvent (i.e., freeze drying), or at ambient pressure (i.e., ambient-pressure drying). Ambient pressure drying may also comprise replacing the solvent contained in the pores of the solvent-exchanged gel 26 with camphor dissolved in a solvent and then heating the gel to evaporate the solvent and to sublime the camphor.

In additional exemplifications, there are insufficient hydroxyl and carboxyl moieties on the surface of the seaweed fibers to enable the formation of a cohesive seaweed gel 20 via crosslinking. The amount of carboxyl groups on the surface of the seaweed fibers can be increased by bleaching the fibers prior to gelation. Bleaching can be conducted before, during, or following high-shear mixing by mixing a bleaching agent into the seaweed suspension or seaweed dispersion 16. The bleaching agent can be sodium hypochlorite, chlorine dioxide, ozone, hydrogen peroxide, peracetic acid, or mixtures thereof. The amount of bleaching agent is typically less than about 5 mmol/g seaweed—e.g., less than about 2 mmol/g seaweed, less than about 1 mmol/g seaweed, less than about 0.5 mmol/g seaweed, or, in more particular embodiments, at most 0.2 mmol/g seaweed.

In additional exemplifications, where there are insufficient hydroxyl and carboxyl moieties on the surface of the seaweed fibers to enable the formation of a cohesive seaweed gel 20 via crosslinking, the amount of carboxyl groups on the surface of the seaweed fibers can be increased by oxidizing the fibers prior to gelation. Oxidation can be conducted before, during, or following high-shear mixing by mixing sodium hypochlorite, sodium hydroxide, 2,2,6,6-tetramethylpiperidine-1-oxyl, and sodium bromide into the seaweed suspension or seaweed dispersion 16. The amount of 2,2,6,6-tetramethylpiperidine-1-oxyl is typically less than about 0.02 g/g seaweed—e.g., less than about 0.01 g/g seaweed, less than about 0.005 g/g seaweed, less than about 0.002 g/g seaweed, or, in more particular embodiments, at most 0.001 g/g seaweed. The amount of sodium bromide is typically less than about 0.2 g/g seaweed—e.g., less than about 0.1 g/g seaweed, less than about 0.05 g/g seaweed, less than about 0.02 g/g seaweed, or, in more particular embodiments, at most 0.01 g/g seaweed. The amount of sodium hypochlorite is typically less than about 0.5 g/g seaweed—e.g., less than about 0.2 g/g seaweed, less than about 0.1 g/g seaweed, less than about 0.05 g/g seaweed, less than about 0.02 g/g seaweed, or, in more particular embodiments, at most 0.01 g/g seaweed.

In additional exemplifications, the carboxyl content of the seaweed dispersion 16 following bleaching or oxidation is typically less than about 1 mmol/g seaweed—e.g., less than about 0.5 mmol/g seaweed, less than about 0.3 mmol/g seaweed, less than about 0.2 mmol/g seaweed, or, in more particular embodiments, at most 0.1 mmol/g seaweed. While higher carboxyl contents enable more extensive crosslinking within the seaweed gel and increase gel cohesion, lower carboxyl contents can be realized with a smaller amount of bleach or oxidant, which reduces the cost of seaweed gel production.

In some embodiments, the seaweed gel 20 may be reinforced with a fiber comprising a glass, carbon, a biopolymer (e.g., cellulose, chitin, viscose, or wool), a polymer (e.g., polyamide, polyethylene, polypropylene, polyurethane, polyacrylonitrile, polyethylene terephthalate, or polybutylene terephthalate), a ceramic (e.g., silica, alumina, or zirconia), or mixtures thereof.

### Insulation Properties

The insulation 30 can have a density less than about 0.5 g/cm³—e.g., less than about 0.2 g/cm³, less than about 0.1 g/cm³, less than about 0.05 g/cm³, less than about 0.02 g/cm³, or even less than about 0.01 g/cm³.

The insulation 30 can have an average pore dimension of less than about 1 micron—e.g., less than about 0.3 microns, less than about 0.1 microns, less than about 0.05 microns, less than about 0.02 microns, or even less than about 0.01 microns.

The insulation 30 can have a surface area of greater than about 20 m²/g—e.g., greater than about 50 m²/g, greater than about 100 m²/g, greater than about 300 m²/g, or even greater than about 1,000 m²/g.

The insulation 30 can have a thermal conductivity less than about 35 mW/mK—e.g., less than about 30 mW/mK, less than about 25 mW/mK, less than about 20 mW/mK, or even less than about 15 mW/mK at 25° C.

The following examples illustrate methods of preparing the insulation.

### EXEMPLIFICATIONS

### Example 1: Preparation of Seaweed Dispersion

An aqueous suspension comprising 7.4-weight-percent seaweed (skinny kelp powder from Atlantic Sea Farms of Biddeford, Maine, USA) was processed in a benchtop supermasscolloider (grinding machine) (from Masuko Sangyo Co., Ltd of Kawaguchi, Saitama, Japan) to a net energy input of 1.5 kWh/kg seaweed to form a seaweed dispersion. FIG. 2 represents an image of the dispersion following dilution to 0.05 weight percent and drying on a foil substrate. Visible in the image are fibers with an average diameter of less than approximately 0.1 microns.

### Example 2: Preparation of Bleached Softwood Kraft Dispersion

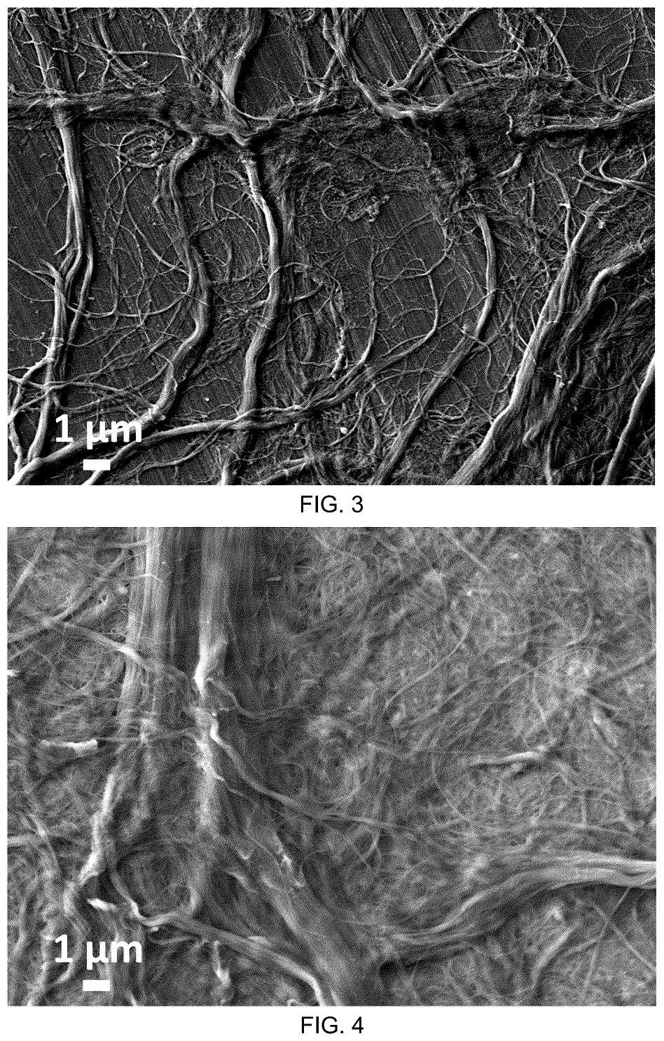

An aqueous suspension comprising 1.5-weight-percent bleached softwood kraft pulp was processed in the benchtop supermasscolloider (from Masuko Sangyo Co., Ltd) to a net energy input of 10 kWh/kg seaweed to form a cellulose-rich dispersion. FIG. 3 represents an image of the dispersion following dilution to 0.05 weight percent and drying on a foil substrate. Visible in the image are fibers with diameters ranging from less than approximately 0.1 microns to approximately 1 micron.

### Example 3: Preparation of Flax Dispersion

An aqueous suspension comprising 2.5-weight-percent flax was processed in the benchtop supermasscolloider (from Masuko Sangyo Co., Ltd) to a net energy input of 8.2 kWh/kg seaweed to form a flax dispersion. FIG. 4 represents an image of the dispersion following dilution to 0.05 weight percent and drying on a foil substrate. Visible in the image are fibers with diameters ranging from less than approximately 0.1 microns to approximately 2 microns.

### Example 4: Preparation of Seaweed Insulation

An aqueous suspension comprising 7.4-weight-percent seaweed (skinny kelp powder from Atlantic Sea Farms) was processed in the benchtop supermasscolloider (from Masuko Sangyo Co., Ltd) to a net energy input of 1.5 kWh/kg seaweed to form a seaweed dispersion. 27.6 g of seaweed dispersion was mixed with 18.4 g of water to form a 6-weight-percent seaweed dispersion in a 63-mm-diameter polypropylene jar. 25.0 g of 5-weight-percent aqueous calcium chloride (from Sigma-Aldrich) solution was added to the seaweed dispersion and allowed to react at 20° C. for 18 hours. The seaweed gel was then removed from the jar and transferred to a solvent-exchange bath including tert-butanol.

The volume of the solvent-exchange bath was approximately 3 times the volume of the gel. The seaweed gel was soaked in the solvent-exchange bath for 5 days, wherein the solvent was replaced with fresh tert-butanol twice per day, to yield a solvent-exchanged gel in which the tert-butanol solution in the pores of the gel contained less than 0.2-weight-percent water. The solvent-exchanged gel was cooled to less than 5° C. for 2 hours and then freeze-dried at ambient temperature and subjected to a vacuum pressure of less than 50 mtorr for 24 hours to remove the solidified tert-butanol from the pores.

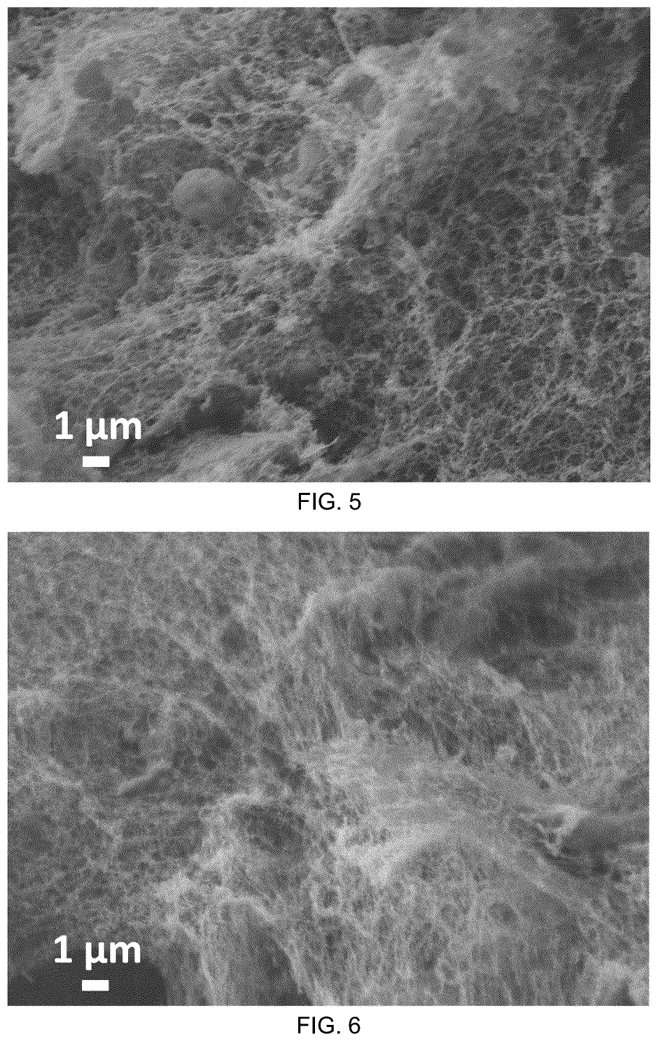

The resulting insulation has a bulk density of 0.08 g/cm³. When compressed to a bulk density of 0.10 g/cm³, the insulation exhibits a thermal conductivity of 29.3 mW/mK at 25° C. FIG. 5 represents an image of the cross-section of the insulation. Visible in the image are fibers with an average diameter of less than approximately 0.1 microns, wherein the fibers define pores that range in size from less than approximately 0.1 microns to approximately 1 micron.

### Example 5: Preparation of Seaweed Insulation

An aqueous suspension comprising 7.4-weight-percent seaweed (skinny kelp powder from Atlantic Sea Farms) was processed in the benchtop supermasscolloider (from Masuko Sangyo Co., Ltd) to a net energy input of 1.5 kWh/kg seaweed to form a seaweed dispersion. 100 g of seaweed dispersion was then washed three times with 400 g acetone to remove salt and acetone-soluble organics and dried at 85° C.

0.99 g of dried seaweed was suspended in 49.0 g of water to form a 2-weight-percent seaweed dispersion in a 63-mm-diameter polypropylene jar. 20.0 g of 5-weight-percent aqueous calcium chloride (from Sigma-Aldrich) solution was added to the seaweed dispersion and allowed to react at 20° C. for 18 hours. The seaweed gel was then removed from the jar and transferred to a solvent-exchange bath including tert-butanol.

The volume of the solvent-exchange bath was approximately three times the volume of the gel. The seaweed gel was soaked in the solvent-exchange bath for five days, wherein the solvent was replaced with fresh tert-butanol twice per day to yield a solvent-exchanged gel in which the tert-butanol solution in the pores of the gel contained less than 0.2-weight-percent water. The solvent-exchanged gel was cooled to less than 5° C. for two hours and then freeze-dried at ambient temperature and subjected to a vacuum pressure of less than 50 mtorr for 24 hours to remove the solidified tert-butanol from the pores.

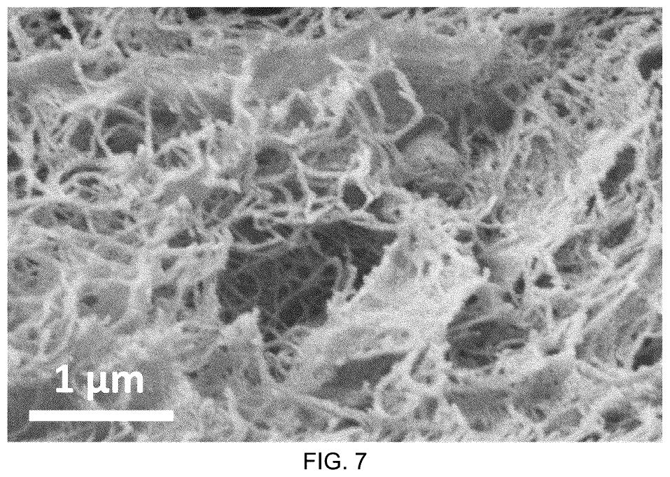

The resulting insulation has a bulk density of 0.05 g/cm³. The insulation has a surface area of 130 m²/g. When compressed to a bulk density of 0.07 g/cm³, the insulation exhibits a thermal conductivity of 25.2 mW/mK at 25° C. FIG. 6 represents an image of the cross-section of the insulation. Visible in the image are fibers with an average diameter of less than approximately 0.1 microns, wherein the fibers define pores that range in size from less than approximately 0.1 microns to approximately 1 micron.

### Example 6: Preparation of Seaweed Insulation

An aqueous suspension comprising 7.4-weight-percent seaweed (skinny kelp powder from Atlantic Sea Farms) was processed in the benchtop supermasscolloider (from Masuko Sangyo Co., Ltd) to a net energy input of 1.5 kWh/kg seaweed to form a seaweed dispersion. 100 g of seaweed dispersion was then washed three times with 400 g of acetone to remove salt and acetone-soluble organics and dried at 85° C.

1.35 g of dried seaweed was suspended in 43.7 g of water to form a 3-weight-percent seaweed dispersion. 1.4 g of 20-weight-percent aqueous polyethyleneimine (800 Da, from Sigma-Aldrich) and 0.6 g of epichlorohydrin (from Sigma-Aldrich) were mixed into the seaweed dispersion for 15 minutes at ambient temperature. The mixture was sealed into a 63-mm-diameter polypropylene jar and heated at 55° C. for 18 hours to form a seaweed gel. Following cooling to ambient temperature, the seaweed gel was removed from the jar and transferred to a solvent-exchange bath including tert-butanol.

The volume of the solvent-exchange bath was approximately three times the volume of the gel. The seaweed gel was soaked in the solvent-exchange bath for five days, wherein the solvent was replaced with fresh tert-butanol twice per day to yield a solvent-exchanged gel in which the tert-butanol solution in the pores of the gel included less than 0.2-weight-percent water. The solvent-exchanged gel was cooled to less than 5° C. for two hours and then freeze-dried at ambient temperature and subjected to a vacuum pressure of less than 50 mtorr for 24 hours to remove the solidified tert-butanol from the pores.

The resulting insulation has a bulk density of 0.09 g/cm³. When compressed to a bulk density of 0.12 g/cm³, the insulation exhibits a thermal conductivity of 29.0 mW/mK at 25° C.

### Example 7: Preparation of Seaweed Insulation

An aqueous suspension comprising 9.3-weight-percent seaweed (skinny kelp powder from Atlantic Sea Farms) was processed in the supermasscolloider (from Masuko Sangyo Co., Ltd) to a net energy input of 2.0 kWh/kg seaweed to form a seaweed dispersion. 505 g of seaweed dispersion was then washed six times with 1000 g of acetone to remove salt and acetone-soluble organics and dried at 85° C.

1.25 g of dried seaweed was suspended in 49 g water to form a 2.5-weight-percent seaweed dispersion. 1.7 g of 20-weight-percent aqueous polyethyleneimine (800 Da, from Sigma-Aldrich) and 0.5 g of epichlorohydrin (from Sigma-Aldrich) were mixed into the dispersion for 15 minutes at ambient temperature. The mixture was sealed into a 63-mm-diameter polypropylene jar and heated at 55° C. for 18 hours to form a seaweed gel. Following cooling to ambient temperature, the seaweed gel was removed from the jar and transferred to a solvent-exchange bath including acetone.

The volume of the solvent-exchange bath was approximately five times the volume of the gel. The seaweed gel was soaked in the solvent-exchange bath for three days, wherein the solvent was replaced with fresh acetone once per day to yield a solvent-exchanged gel in which the acetone solution in the pores of the gel included less than 0.8-weight-percent water. 62 g of camphor (from Sigma-Aldrich) was placed upon the surface of the gel and allowed to diffuse into the gel for 36 hours. The solvent-exchanged gel was heated to 160° C. at ambient pressure for seven hours to evaporate the acetone and to sublime precipitated camphor from the pores.

The resulting insulation has a bulk density of 0.06 g/cm³.

### Example 8: Preparation of Oxidized Seaweed Insulation

An aqueous suspension comprising 8.5-weight-percent seaweed (skinny kelp powder from Atlantic Sea Farms) was processed in the supermasscolloider (from Masuko Sangyo Co., Ltd) to a net energy input of 2.5 kWh/kg seaweed to form a seaweed dispersion.

250 g of the seaweed dispersion was suspended in 500 g water to form a 2.8-weight-percent seaweed dispersion. 36 mg of 2,2,6,6-tetramethylpiperidine-1-oxyl (from Sigma-Aldrich) and 0.32 g sodium bromide (from Sigma-Aldrich) were mixed with the seaweed dispersion for 10 minutes. 19.1 g of 12.5% sodium hypochlorite (from Sigma-Aldrich) was added to the dispersion and stirred for 1 hour while periodically adding 5% sodium hydroxide (from Sigma-Aldrich) solution dropwise to maintain the pH of the dispersion at 10. The dispersion was then filtered, washed with water, and resuspended in water to yield a 1.7-weight-percent oxidized seaweed dispersion.

50 g of the 1.7-weight-percent oxidized seaweed dispersion was processed in a benchtop ultrasonicator (Model HLUH00015 from U.S. Solids of Cleveland, OH, USA) to a gross energy input of 22 kWh/kg seaweed. 0.5 g of 20-weight-percent aqueous polyethyleneimine (800 Da, from Sigma-Aldrich) and 0.2 g of epichlorohydrin (from Sigma-Aldrich) were mixed into the dispersion for 15 minutes at ambient temperature. The mixture was sealed into a 63-mm-diameter polypropylene jar and heated at 55° C. for 18 hours to form an oxidized seaweed gel. Following cooling to ambient temperature, the oxidized seaweed gel was removed from the jar and transferred to a solvent-exchange bath including tert-butanol.

The volume of the solvent-exchange bath was approximately equal to the volume of the gel. The oxidized seaweed gel was soaked in the solvent-exchange bath for five days, wherein the solvent was replaced with fresh tert-butanol twice per day to yield a solvent-exchanged gel in which the tert-butanol solution in the pores of the gel included less than 0.1-weight-percent water. The solvent-exchanged gel was cooled to less than 5° C. for two hours and then freeze-dried at ambient temperature and subjected to a vacuum pressure of less than 50 mtorr for 24 hours to remove the solidified tert-butanol from the pores.

The resulting insulation has a bulk density of 0.08 g/cm³. When compressed to a bulk density of 0.11 g/cm³, the insulation exhibits a thermal conductivity of 27.8 mW/mK at 25° C.

### Example 9: Preparation of Oxidized Seaweed Insulation

9.2 g of sugar kelp (from Maine Seacoast Vegetables of Hancock, ME, USA) was suspended in 300 g water for one hour, filtered to extract salts and readily soluble polysaccharides, and then resuspended in water to yield 483 g of a 1.5-weight-percent seaweed dispersion. 31 mg of 2,2,6,6-tetramethylpiperidine-1-oxyl (from Sigma-Aldrich) and 0.71 g sodium bromide (from Sigma-Aldrich) were mixed with the seaweed dispersion for 10 minutes. 34.0 g of 12.5% sodium hypochlorite (from Sigma-Aldrich) was added to the dispersion and stirred for 1 hour while periodically adding 5% sodium hydroxide (from Sigma-Aldrich) solution dropwise to maintain the pH of the dispersion at 10. The dispersion was then filtered, washed with water, and resuspended in water to yield a 1.0-weight-percent oxidized seaweed dispersion.

45 g of the 1.0-weight-percent oxidized seaweed dispersion was processed in a benchtop ultrasonicator (Model HLUH00015 from U.S. Solids of Cleveland, OH, USA) to a gross energy input of 66 kWh/kg seaweed. 0.2 g of 20-weight-percent aqueous polyethyleneimine (800 Da, from Sigma-Aldrich) was mixed into the dispersion for 10 seconds at ambient temperature. The mixture was sealed into a 63-mm-diameter polypropylene jar and heated at 55° C. for 18 hours to form an oxidized seaweed gel. Following cooling to ambient temperature, the oxidized seaweed gel was removed from the jar and transferred to a solvent-exchange bath including tert-butanol.

The volume of the solvent-exchange bath was approximately equal to the volume of the gel. The oxidized seaweed gel was soaked in the solvent-exchange bath for four days, wherein the solvent was replaced with fresh tert-butanol twice per day to yield a solvent-exchanged gel in which the tert-butanol solution in the pores of the gel included less than 0.1-weight-percent water. The solvent-exchanged gel was cooled to less than 5° C. for two hours and then freeze-dried at ambient temperature and subjected to a vacuum pressure of less than 50 mtorr for 24 hours to remove the solidified tert-butanol from the pores.

The resulting insulation has a bulk density of 0.02 g/cm³. When compressed to a bulk density of 0.10 g/cm³, the insulation exhibits a thermal conductivity of 20.9 mW/mK at 25° C. FIG. 7 represents an image of the cross-section of the insulation. Visible in the image are fibers with an average diameter of less than approximately 0.1 microns, wherein the fibers define pores that range in size from less than approximately 0.1 microns to approximately 1 micron.

Use of these methods for producing insulation can offer many advantages over the use of previously known methods for the production of porous insulation materials.

An advantage provided by embodiments of the method is that the majority of the insulation can be seaweed, which is a renewable resource that can be sustainably produced without freshwater irrigation, fertilizer run-off, or land-use concerns. Seaweeds that are generally regarded as a nuisance and that are typically landfilled or composted (e.g., sargassum) may also be used as a feedstock for these methods.

Another advantage provided by embodiments of the method is that the thermal conductivity of the seaweed insulation can be lower than that of conventional bio-derived insulations and comparable to or lower than that of conventional polymer-foam insulations. The lower thermal conductivity arises from the small pores present in the fibrous microstructure of the seaweed gel, which in turn arises from the small-diameter fibers present in the seaweed dispersion.

Another advantage provided by embodiments of the method is that the small-diameter fibers present in the seaweed dispersion can be released from the seaweed feedstock via fibrillation at lower energy input than other bio-derived fibers, such as bleached softwood kraft pulp and flax.

In describing embodiments of the invention, specific terminology is used for the sake of clarity. For purposes of description, each specific term is intended to at least include all technical and functional equivalents that operate in a similar manner to accomplish a similar purpose.

Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements, and features discussed herein in connection with one embodiment can likewise be used in conjunction with other embodiments. The contents of all references, including reference texts, journal articles, patents, patent applications, etc., cited throughout this application are hereby incorporated by reference in their entirety. All appropriate combinations of embodiments, features, characterizations, components, and methods of those references and the present disclosure may be selected for inclusion in embodiments of the invention. Still further, the components and methods identified in the Background section are integral to this disclosure and can be used in conjunction with or substituted for components and methods described elsewhere in the disclosure within the scope of the invention.

1. A method for manufacturing an insulation, the method comprising:
subjecting a liquid suspension of seaweed to shear to reduce particle size, to release seaweed fibers from the seaweed matrix, and to form a seaweed dispersion; then
inducing gelation of the seaweed dispersion to form a gel comprising a liquid containing a three-dimensional network of the seaweed fibers; and then drying the gel.

2. The method of claim 1, wherein the liquid suspension of seaweed is formed by mixing seaweed with water at a seaweed concentration of less than 8 weight percent.

3. The method of claim 1, wherein the shear is created within a blender, homogenizer, microfluidizer, refiner, supermasscolloider, or ultrasonicator.

4. The method of claim 3, wherein less than 10 kWh of energy per kg seaweed is supplied to the blender, homogenizer, microfluidizer, refiner, supermasscolloider, or ultrasonicator to generate the shear.

5. The method of claim 1, wherein the seaweed fibers have an average diameter of less than 0.1 microns.

6. The method of claim 1, wherein gelation is induced by mixing a crosslinker into the seaweed dispersion and heating the mixture.

7. The method of claim 6, wherein the crosslinker comprises a polyamine and epichlorohydrin.

8. The method of claim 1, further comprising bleaching or oxidizing the seaweed.

9. The method of claim 8, wherein the bleached or oxidized seaweed fibers include less than 0.3 mmol carboxyl per gram of seaweed.

10. The method of claim 1, further comprising replacing the liquid with a solvent prior to drying.

11. The method of claim 1, wherein the gel is dried by replacing the liquid contained in the pores of the gel with air via supercritical drying, freeze drying, or ambient-pressure drying.

12. The method of claim 1, wherein the gel is dried by replacing the liquid contained in the pores of the gel with camphor dissolved in a solvent and then heating the gel to evaporate the solvent and to sublime the camphor.

13. The method of claim 1, wherein the insulation has a bulk density between 0.02 and 0.2 g/cm³.

14. The method of claim 1, wherein the insulation has an average pore dimension of less than 1 micron.

15. The method of claim 1, wherein the insulation exhibits a thermal conductivity of less than 30 mW/mK.

16. A thermal insulation, the insulation comprising:
a network of fibers that define pores with dimensions smaller than 1 micron, wherein the network of fibers comprises:
70 to 98 weight percent seaweed; and
2 to 30 weight percent crosslinker.

17. The insulation of claim 16, wherein the fibers have an average diameter of less than 0.1 microns.

18. The insulation of claim 16, wherein the crosslinker comprises a polyamine and epichlorohydrin.

19. The insulation of claim 16, wherein the insulation exhibits a thermal conductivity of less than 30 mW/mK.

20. The insulation of claim 16, wherein the insulation has a bulk density between 0.02 and 0.2 g/cm³.
